(19) United States
(12) Patent Application Publication
(10) Pub. No.: US 2009/0154423 A1
(43) Pub. Date: Jun. 18, 2009

(54) METHOD OF ACCESSING OPTIMAL ACCESS NETWORK USING ACCESS GATEWAY IN MOBILE TERMINAL

(75) Inventors: Pyeong-jung SONG, Daejeong-si (KR); Soo-chang Kim, Daejeon-si (KR); Yeon-seung Shin, Deajeon-si (KR); Yeong-jin Kim, Daejeon-si (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Deajeon-si (KR)

(21) Appl. No.: 12/323,730

(22) Filed: Nov. 26, 2008

(30) Foreign Application Priority Data
Dec. 14, 2007 (KR) 10-2007-0131021

(51) Int. Cl. H04W 4/00

(52) U.S. Cl. 370/331

(57) ABSTRACT

Provided is a method of causing a mobile terminal to access an optimal access network using an access gateway. By searching for neighboring access network nodes periodically to select an optimal access network node when the mobile terminal accesses a serving access network node or when the mobile terminal performs handover, and accessing the selected optimal access network node through the access gateway to communicate with the optimal access network, it is possible to reduce communication costs and provide high-quality communication services to users without installing any additional apparatus require for heterogeneous networking. Furthermore, by performing authentication, registration, and QoS control in advance before accessing the optimal access network node, it is possible to reduce a time consumed to access the optimal access network node.

### CROSS REFERENCE TO RELATED APPLICATIONS

This application claims priority from Korean Patent Application No. 10-2007-0131021, filed on Dec. 14, 2007, the disclosure of which is incorporated herein in its entirety by reference.

### BACKGROUND OF THE INVENTION

1. Field of the Invention

The present invention relates to a method of causing a mobile terminal to access an optimal access network, and more particularly, to a method of causing a mobile terminal to access an access network node with optimal quality of service (QoS), using an access gateway.

This work was supported by the IT R&D program of Ministry of Information and Communication (MIC)/Institute for Information Technology Advancement (IITA) [2005-S-404-23, Research and development on 3G long-term evolution access system].

2. Description of the Related Art

A heterogeneous network system is a network system in which service coverages of wireless network systems having different characteristics overlap hierarchically. The heterogeneous network system provides an environment where a subscriber can access an optimal network selectively and flexibly according to his or her current location, a current propagation environment, service characteristics, his or her preferences, etc.

Quality of service (QoS) depends on the environment of a network to which a subscriber is connected to provide a service. Even when the network environment to which the subscriber is connected is not suitable to provide the service, the service should be provided through the network until handover is performed, which causes consumption in time, economical losses, etc. Therefore, it is needed to select an optimal network suitable to provide a desired service before the service is provided, or to select an optimal network suitable to provide a desired service before handover is performed while the service is provided.

### SUMMARY OF THE INVENTION

The present invention provides a method of causing a mobile terminal to select an optimal network having high quality of service (QoS) and access the optimal network through an access gateway when the mobile terminal accesses a network or when the mobile terminal performs handover.

The present invention discloses a method of causing a mobile terminal to access an optimal network, by searching for neighboring access network nodes periodically to select an optimal access network node when the mobile terminal accesses a serving access network node or when the mobile terminal performs handover, and accessing the selected optimal access network node through an access gateway.

According to an aspect of the present invention, there is provided a method of accessing an optimal access network in a mobile terminal, including: measuring signal intensities of a serving access network node and at least one adjacent access network node which the mobile terminal is capable of accessing, for each predetermined period, and transmitting information about the signal intensities to the serving access network node; and accessing an optimal access network node through an access gateway according to information of the optimal access network node received from the serving access network node. The mobile terminal can measure the signal intensities of the serving access network node and the at least one neighboring access network node for each predetermined period when the mobile terminal accesses the serving access network node or when the mobile terminal performs handover.

According to another aspect of the present invention, there is provided a method of selecting an optimal access network in a serving access network node, including: estimating at least one adjacent network, using at least one signal intensity received from a mobile terminal and information of adjacent network resources; and selecting an optimal access network node on the basis of the result of the estimation, and transmitting the result of the selection to the mobile terminal and an access gateway.

According to another aspect of the present invention, there is provided a method of causing an access gateway to access an optimal access network, including: determining whether information of an optimal access network for communicating with a mobile terminal is received from a serving access network node; if the information of the optimal access network is received, establishing a communication path between the mobile terminal and the optimal access network node; and if the mobile terminal accesses the optimal access network node, changing a data transmission path to the serving access network node to a data transmission path to the optimal access network node.

According to another aspect of the present invention, there is provided a method of accessing an optimal access network in a heterogeneous network system, including: in a mobile terminal, measuring signal intensities of a serving access network node and at least one adjacent access network node for each predetermined period when the mobile terminal accesses the serving access network node or when the mobile terminal performs handover, and transmitting the measured signal intensities to the serving access network node; in the serving access network node, selecting an optimal access network node using the received signal intensities and information of adjacent network resources, and transmitting information of the optimal access network node to the mobile terminal and the access gateway; in the access gateway, establishing a communication path between the mobile terminal and the selected optimal access network node using a predetermined routing table; and in the mobile terminal, receiving a traffic channel allocated by the optimal access network node, through the communication path, and wirelessly accessing the optimal access network node through the traffic channel.

Additional aspects of the invention will be set forth in the description which follows, and in part will be apparent from the description, or may be learned by practice of the invention.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the aspects of the invention.

FIG. 1 is a block diagram of a heterogeneous network system according to an embodiment of the present invention;

FIG. 2 is a flowchart of a method of accessing an optimal access network in a heterogeneous network system, according to an embodiment of the present invention;

FIG. 3 is a flowchart of a method of measuring signal intensities of access network nodes which a mobile terminal can access in the mobile terminal, according to an embodiment of the present invention; and

FIG. 4 is a flowchart of a method of selecting an optimal access network in a serving access network node, according to an embodiment of the present invention.

### DETAILED DESCRIPTION OF EXEMPLARY EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

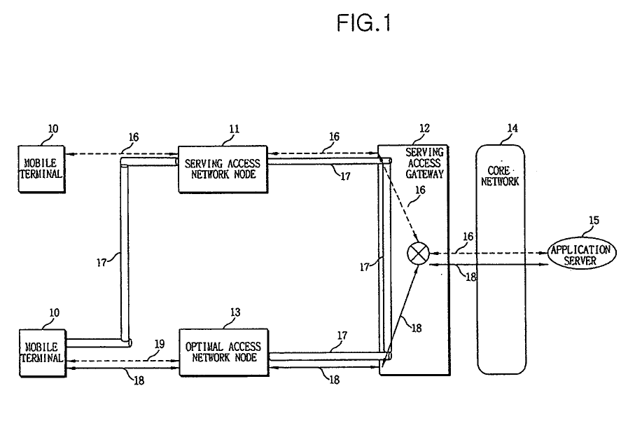

FIG. 1 is a block diagram of a heterogeneous network system according to an embodiment of the present invention.

Referring to FIG. 1, the heterogeneous network system includes a mobile terminal 10, a serving access network node 11, and a serving access gateway 12.

The mobile terminal 10 measures signal intensities of the serving access network node 11 and at least one neighboring access network node for each predetermined period when the mobile terminal 10 accesses the serving access network node 11 or when the mobile terminal 10 performs handover, transmitting the results of the measurement to the serving access network node 11, and accesses an optimal access network node 13 through a communication path 17 formed between the mobile terminal 10 and the optimal access network node 13.

That is, the mobile terminal 10 calculates a performance value of the serving access network node 11 using service information and the signal intensity of the serving access network node 11. The mobile terminal 10 measures the signal intensity of the at least one neighboring access network node which the mobile terminal 10 can access if the performance value is below a predetermined performance value. The service information may include information about quality of service (QoS) of the serving access network node 11, information about charging of service fees, etc.

Meanwhile, the mobile terminal 10 receives a traffic channel allocated by the optimal access network node 13 through the communication path 17 formed between the mobile terminal 10 and the optimal access network node 13, and wirelessly accesses the optimal access network node 13 through the traffic channel.

The serving access network node 11 selects the optimal access network node 13 using information of neighboring network resources and information about the signal intensities received from the mobile terminal 10, and transmits the result of the selection to the mobile terminal 10. The information of adjacent network resources includes levels of traffic loads of adjacent networks, a maximum service speed, QoS, charging levels of the service, the battery capacity of the mobile terminal, and the moving speed of the mobile terminal.

The serving access gateway 12 forms the communication path 17 between the mobile terminal 10 and the optimal access network node 13 using a predetermined routing table (not shown). Here, the predetermined routing table can include identification numbers (IDs), IP addresses, etc. of the adjacent access network nodes. Also, if the mobile terminal 10 accesses the optimal access network node 13, the serving access gateway 12 switches a data transmission path to the serving access network node 11 to a data transmission path to the optimal access network node 13. That is, a data transmission path is changed from a data transmission path 16 to a data transmission path 18. Accordingly, data is transmitted and received between the application server 15 and the mobile terminal 10 through the data transmission path 18.

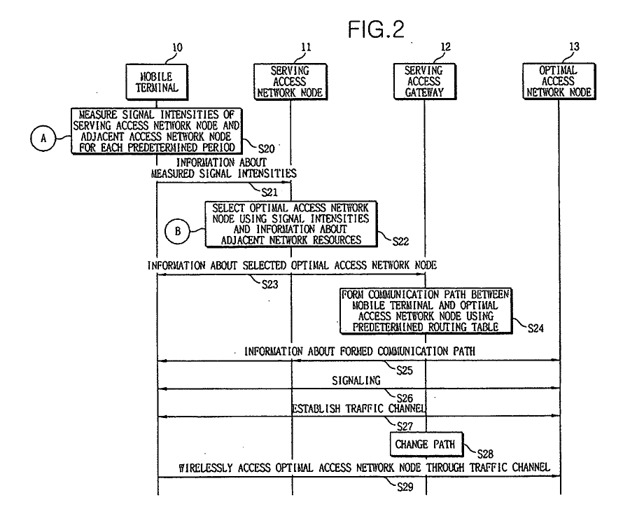

An optimal access network accessing method which is performed by the heterogeneous network system according to the current embodiment of the present invention will be described with reference to FIG. 2, below.

As illustrated in FIG. 2, in the optimal access network accessing method according to an embodiment of the present invention, a mobile terminal 10 measures signal intensities of a serving access network node 11 and at least one adjacent access network node for each predetermined period when the mobile terminal 10 accesses the serving access network node 11 or when the mobile terminal 10 performs handover, and transmits the results of the measurement to the serving access network node 11. The serving access network node 11 selects an optimal access network node 13 using the received signal intensities and information of adjacent network resources, and transmits information of the selected optimal access network node to the mobile terminal 10 and a serving access gateway 12. Thus, the serving access gateway 12 forms a communication path between the mobile terminal 10 and the optimal access network node 13 using a predetermined routing table. Thereafter, the mobile terminal 10 receives a traffic channel from the optimal access network node 13 through the communication path, and wirelessly accesses the optimal access network node 13 through the traffic channel.

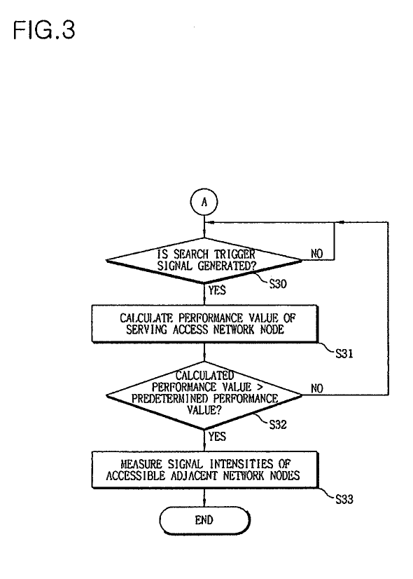

The mobile terminal 10 measures signal intensities of the serving access network node 11 and at least one adjacent access network node for each predetermined period when the mobile terminal 10 accesses the serving access network node 11 or when the mobile terminal 10 performs handover (operation S20). This operation will be described in detail with reference to FIG. 3, below.

As illustrated in FIGS. 1 and 3, the mobile terminal 10 determines whether a search trigger signal is generated for each predetermined period when the mobile terminal 10 accesses the serving access network node 11 or when the mobile terminal 10 performs handover (operation S30). The search trigger signal is used to detect an access network node through which the mobile terminal 10 can stably perform a service. If the search trigger signal is generated, the mobile terminal 10 measures performance of the serving access network node 11 (operation S31). That is, the mobile terminal 10 calculates a performance value of the serving access network node 11 using service information and the signal intensity of the serving access network node 11. Here, the service information can include QoS information, charging information, etc. of a service which is performed by the serving access network node 11. Further, the performance value of the serving access network node 11 is information about performance of the mobile terminal 10 which is measured in a time defined by the search trigger signal.

If the performance value is greater than a predetermined value, the mobile terminal 10 measures signal intensities of adjacent access network nodes which the mobile terminal 10 can access (operation S33). The serving access network node 11 and access network nodes that have not been registered to a provider when they initially subscribe for the service are excluded out of the adjacent access network nodes whose signal intensities are to be measured. The reason of excluding the serving access network node 11 is because the performance value of the serving access network node 11 has been already compared.

In detail, the signal intensities of the adjacent access network nodes are measured using wireless measurement parameters of the adjacent access network nodes. The wireless measurement parameters can include IDs of the adjacent access network nodes, carrier frequencies, available bandwidths, subcarrier information, and information about measurement scheduling patterns required for measuring the signal intensities of the adjacent access network nodes. The information about the measurement scheduling patterns can be defined according to a communication protocol which is used in the adjacent access networks. The mobile terminal 10 measures the signal intensities of the adjacent access network nodes according to the information about the measurement scheduling patterns.

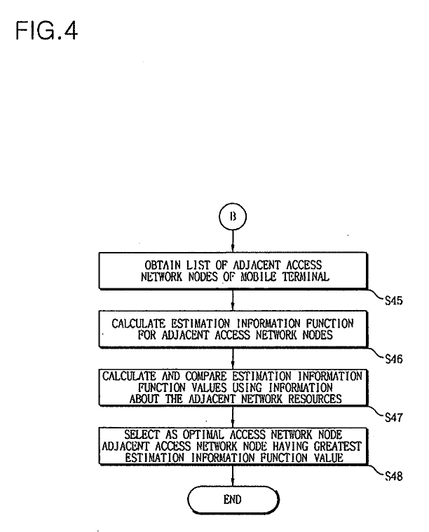

The mobile terminal 10 transmits information about the signal intensities of the adjacent access network nodes to the serving access network node 11 (operation S21). The serving access network node 11 selects an optimal access network node using the information about the signal intensities and information of adjacent network resources (operation S22). This process will be described in detail with reference to FIG. 4, below.

As illustrated in FIGS. 1 and 4, the serving access network node 11 obtains information of adjacent access network nodes from the information about the signal intensities of the adjacent access network nodes (operation S45). Thereafter, the serving access network node 11 configures an estimation information function for the adjacent access network nodes (operation S46). Here, variables of the estimation information function may be the information about the received signal intensities and the information of the adjacent network resources. The information of the adjacent network resources may be levels of traffic loads of the adjacent access networks, a maximum service speed for each adjacent access network, QoS, charging levels of the service, the battery capacity of the mobile terminal 10, and the moving speed of the mobile terminal 10.

The serving access network node 11 calculates values of estimation information functions using the information of the adjacent network resources and the information about the signal intensities (operation S47), and compares the estimation information function values with each other (operation S47). Then, the serving access network node 11 selects as an optimal access network node an adjacent access network node having the greatest estimation information function value of the estimation information function values (operation S48).

The serving access network node 11 transmits the information of the optimal access network node to the mobile terminal 11 and the serving access gateway 12 (operation S23). The serving access gateway 12 forms a communication path between the mobile terminal 10 and the optimal access network node 13 using a predetermined routing table (operation S24). The serving access gateway 12 transmits information about the communication path to the mobile terminal 10, the serving access network node 11, and the optimal access network node 13 (operation S25).

The predetermined routing table may include ID and IP address information of at least one access network node. That is, the serving access gateway 12 obtains an IP address of the optimal access network node 13 from the predetermined routing table, and accesses the optimal access network node 13 using the IP address. Accordingly, a communication path between the mobile terminal 10 and the optimal access network node 13 is formed. A path between the mobile terminal 10 and the serving access network node 11 and a path between the serving access network node 11 and the serving access gateway 12 are already known. Accordingly, the path between the mobile terminal 10 and the optimal access network node 13 is formed between the mobile terminal 10, the serving access network node 11, the serving gateway 12, and the optimal access network node 13. Accordingly, by utilizing only the serving access gateway 12 without installing any additional apparatus required for heterogeneous networking, heterogeneous networking can be performed.

Thereafter, the mobile terminal 10 performs signaling with the optimal access network node 13 through the formed communication path (operation S26). A packet including information required for signaling may be encapsulated in a tunnel header. An address of a source included in the tunnel header is an IP address of the mobile terminal 10 or an IP address of the optimal access network node 13, and an address of a destination included in the tunnel header is an IP address of the optimal access network node 13 or an IP address of the mobile terminal 10.

Accordingly, a packet including information required for signaling is not changed by the serving access network node 11 and the serving access gateway 12 on the communication path, and is received or transmitted directly between the mobile terminal 10 and the optimal access network node 13. The mobile terminal 10 performs authentication and registration in connection to the optimal access network node 13 through signaling, and determines T-QoS of the optimal access network node 13. Accordingly, by performing authentication, registration, and T-QoS control before switching to the optimal access network node 13, a time consumed to access the optimal access network node 13 can be reduced. The optimal access network node 13 controls acceptance of the determined T-QoS, allocates an identifier (New C-RNT1) to the mobile terminal 10, and then allocates traffic resources to the mobile terminal 10. Therefore, a traffic channel is established between the mobile terminal 10 and the optimal access network node 13 (operation S27).

If the traffic channel is established, the serving access gateway 28 switches a data transmission path to the serving access network node 11 to a data transmission path to the optimal access network node 13 (operation S28). That is, a data transmission path is changed from the data transmission path 16 to the data transmission path 18. Accordingly, data between the application server 15 and the mobile terminal 10 is received and transmitted through the data transmission path 18. Then, the mobile terminal 10 wirelessly accesses the optimal access network node 13 through the traffic channel (operation S29). Accordingly, in a heterogeneous network system, a mobile terminal searches for adjacent access network nodes periodically and selects an optimal access network node when the mobile terminal accesses a serving access network node or when the mobile terminal performs handover, and performs communications through the optimal access network node, thereby reducing communication costs and providing high-quality communication services.

As described above, in a method of causing a mobile terminal to access an optimal access network using an access gateway, according to an embodiment of the present invention, a mobile terminal searches for adjacent access network nodes periodically and selects an optimal access network node when the mobile terminal accesses a serving access network node or when the mobile terminal performs handover, and accesses the optimal access network node through the access gateway and performs communications with the optimal access network node, thereby reducing communication costs and providing high-quality communication services to users.

Also, by utilizing the access gateway, no additional apparatus is required for heterogeneous networking.

Furthermore, in a method of causing a mobile terminal to access an optimal access network using an access gateway, according to an embodiment of the present invention, by performing authentication, registration, and QoS control in advance before accessing the optimal access network node, a time consumed to access the optimal access network node can be reduced.

It will be apparent to those skilled in the art that various modifications and variations can be made in the present invention without departing from the spirit or scope of the invention. Thus, it is intended that the present invention covers the modifications and variations of this invention provided they come within the scope of the appended claims and their equivalents.

What is claimed is:

1. A method of accessing an optimal access network in a mobile terminal, comprising:
measuring signal intensities of a serving access network node and at least one adjacent access network node which the mobile terminal is capable of accessing, for each predetermined period, and transmitting information about the signal intensities to the serving access network node; and
accessing an optimal access network node through an access gateway according to information of the optimal access network node received from the serving access network node.

2. The method of claim 1, wherein the measuring of the signal intensities of the serving access network node and the at least one adjacent access network node comprises measuring the signal intensities of the serving access network node and the at least one adjacent access network node for each predetermined period when the mobile terminal accesses the serving access network or when the mobile terminal performs handover.

3. The method of claim 2, wherein the measuring of the signal intensities of the serving access network node and the at least one adjacent access network node comprises:
calculating a performance value of the serving access network node using service information and the signal intensity of the serving access network node for each predetermined period when the mobile terminal accesses the serving access network or when the mobile terminal performs handover; and
when the performance value is smaller than a predetermined performance value, measuring the signal intensity of the at least one adjacent access network node.

4. The method of claim 3, wherein the service information comprises at least one information of quality of service (QoS) information of the serving access network and charging information of the service.

5. A method of selecting an optimal access network in a serving access network node, comprising:
estimating at least one adjacent network, using at least one signal intensity received from a mobile terminal and information of adjacent network resources; and
selecting an optimal access network node on the basis of the result of the estimation, and transmitting the result of the selection to the mobile terminal and an access gateway.

6. The method of claim 5, wherein the information of adjacent network resources comprises at least one of levels of traffic loads of the at least one adjacent network, a maximum service speed, QoS, charging levels of the service, a battery capacity of the mobile terminal, and a moving speed of the mobile terminal.

7. A method of causing an access gateway to access an optimal access network, comprising:
determining whether information of an optimal access network for communicating with a mobile terminal is received from a serving access network node;
if the information of the optimal access network is received, establishing a communication path between the mobile terminal and the optimal access network node; and
if the mobile terminal accesses the optimal access network node, changing a data transmission path to the serving access network node to a data transmission path to the optimal access network node.

8. A method of accessing an optimal access network in a heterogeneous network system, comprising:
in a mobile terminal, measuring signal intensities of a serving access network node and at least one adjacent access network node for each predetermined period when the mobile terminal accesses the serving access network node or when the mobile terminal performs handover, and transmitting the measured signal intensities to the serving access network node;
in the serving access network node, selecting an optimal access network node using the received signal intensities and information of adjacent network resources, and transmitting information of the optimal access network node to the mobile terminal and the access gateway;
in the access gateway, establishing a communication path between the mobile terminal and the selected optimal access network node using a predetermined routing table; and
in the mobile terminal, receiving a traffic channel allocated by the optimal access network node, through the communication path, and wirelessly accessing the optimal access network node through the traffic channel.
